(19) United States
(12) Patent Application Publication
(10) Pub. No.: US 2011/0136248 A1
(43) Pub. Date: Jun. 9, 2011

(54) TRANSILLUMINATION MEASUREMENT DEVICE

(75) Inventor: Max Sonnleitner, Linz (AT)

(73) Assignee: NANOIDENT TECHNOLOGIES AG, Linz (AT)

(21) Appl. No.: 12/527,231

(22) PCT Filed: Feb. 11, 2008
(86) PCT No.: PCT/EP2008/001014

§ 371 Date: Feb. 11, 2011

(30) Foreign Application Priority Data
Feb. 17, 2007 (AT) A 237/2007

(51) Int. Cl. G01N 21/00

(52) U.S. Cl. 436/164; 422/82.09

(57) ABSTRACT

The invention relates to a transillumination measurement device for determining the intensity of a chemical/biological reaction, comprising at least one carrier layer, a source and a quantum detector of electromagnetic radiation, and an interface. A reaction membrane is applied to the carrier layer and features at least one chemically/biologically reactive test area. The electromagnetic radiation emitted from the source lies in a first optical spectral range, and the quantum detector features an area that is sensitive to electromagnetic radiation in a second optical spectral range, and the first and second spectral ranges at least partially overlap. The source and the quantum detector of electromagnetic radiation are electrically connected to the interface.

The invention relates to a transillumination measurement device for determining the intensity of a chemical/biological reaction, comprising at least one carrier layer, a source, a quantum detector of electromagnetic radiation and an interface, and a reaction membrane is applied to the carrier layer, and the reaction membrane features at least one chemically/biologically reactive test area, and the electromagnetic radiation emitted from the source lies in a first optical spectral range and the quantum detector features an area that is sensitive to electromagnetic radiation in a second optical spectral range, and the first and second spectral ranges at least partially overlap, and the source and the quantum detector of electromagnetic radiation are electrically connected to the interface; and a process to determine the intensity of a chemical/biological reaction using a transillumination measurement device in which, in addition to the one chemically/biologically reactive test area, the so-called measuring strip, the reaction membrane has another chemically/biologically reactive test area, the so-called control strip, disposed at a distance apart from it and the electromagnetic radiation emitted from the source is attenuated by the chemical/biological reaction in the test area, and the penetrating electromagnetic waves are converted by the quantum detector into an electrical signal proportional to the intensity of the incident waves.

In order to determine whether a particular substance is present in a sample simply and quickly, a test procedure is applied for example, whereby a chemical/biological reaction device reacts to the presence of a particular substance with a color change. Due to the ease of use and rapid availability of results, this measurement principle is often used for qualitative diagnostics—rapid test strips, rapid strip tests or rapid testers are established terms for this. One such measurement device preferably comprises a membrane which operates by capillary action and features a sample application area and at least one chemically/biologically reactive test area, spaced apart from one another. To simplify usage and protect the user, the measurement device may also be disposed in a housing.

Such rapid testers can be used in a number of medical diagnostic and chemical/biological applications. For example, there are rapid tests for diabetic blood sugar measurement, pregnancy tests, HIV tests, as well as blood count and urine analysis to determine so-called critical parameters such as electrolytes, blood gas levels and kidney function values. However, the fields of food and environmental analysis are also preferred applications for these types of rapid test systems. The major advantage lies in the fact that the measurement is easy to carry out, even by untrained personnel, and results are available much faster than would be possible with standard laboratory tests. This is especially important when the results of a test may require action to be taken, for instance administering a drug to a patient or determining the quality of drinking water.

The test area of the rapid strip test is constructed such that, upon contact with the specific substance for which the sample is to be tested, a chemical/biological reaction occurs, preferably indicated by a color change in the test area. The intensity of the color change is approximately directly proportional to the quantity or density of the substance present in the sample. Currently, the color change is usually only qualitatively evaluated because the lack of reference values and subjective evaluation by the user make it difficult to assess the intensity of the reaction accurately. Furthermore, the timing of the readout is important because the reaction is typically time-dependent and the intensity of the color change therefore varies with the duration of the reaction. In order to at least provide a reference system to assess the degree of color change, many rapid strip tests have color comparisons printed on them, to make it possible to make a visual comparison and thus assign a value.

One optical process used to evaluate the intensity of a reaction is called the refractometer measurement process, which makes use of the index of refraction of optical media. The test area of a rapid strip test is illuminated with light of a known wavelength and the intensity of the reflection from the test area is measured. With a measurement device of this type, the sample is placed on the test area and inserted in the measurement device. Through inattention or inappropriate use of the test strip, the test device can become contaminated, requiring at least cleaning, and potentially all subsequent measurements could be distorted if the contamination remains unnoticed.

The objective of the invention is quantitatively to determine the intensity of a reaction in a chemically/biologically reactive test area, such that the inaccuracies of a user-performed readout, particularly a visually compared measurement, are eliminated.

The objective of the invention is achieved, independently in each case, due to the fact that
the source and the quantum detector are placed opposite one another, the direction of the electromagnetic radiation from the source points towards the capture area of the quantum detector and a section of the chemically/biologically reactive test area is placed in the direction of the electromagnetic radiation between the source and the quantum detector;
based on the degree of attenuation, a measurement for the intensity of the chemical/biological reaction is determined.

If the source and the quantum detector are placed opposite one another and the direction of the electromagnetic radiation from the source points towards the capture area of the quantum detector, and a section of the chemically/biologically reactive test area, the so-called measuring strip, is placed in the direction of the electromagnetic radiation, between the source and the quantum detector, then the particular advantage exists that the chemical/biological reaction in the test area is directly influenced by the electromagnetic radiation emitted from the source.

The fact that the electromagnetic radiation emitted from the source can be precisely controlled and is kept at a preferably constant level during the measurement process ensures that the chemical/biological reaction in the test area absorbs a portion of the electromagnetic radiation, and so a smaller quantity of radiation is captured by the quantum detector. Readout problems due to lighting fluctuations, such as can occur with visually compared measurements for instance, can thus advantageously be avoided. A further advantage is that a section of the chemically/biologically reactive test area is placed between the source and the quantum detector of electromagnetic radiation so that, as claimed, it is not necessary for the disclosed transillumination measurement device to have a separate or additional test area. This specifically means that the transillumination measurement device described by the invention can advantageously be used with an existing rapid strip test.

It is of particular advantage if the source of electromagnetic radiation is constructed from a light-emitting diode made from an organic semiconducting material (OLED). OLEDs can be produced cost-effectively from environmentally friendly materials, have minimal power requirements and can be applied to uneven and flexible carrier layers, for example.

Since rapid strip tests are generally intended for one-off use, unit price and disposal issues play a deciding role in their anticipated acceptance. In this respect, organic semiconductors have a decisive advantage over semiconductors made of inorganic materials.

Further embodiments are conceivable in which the source of electromagnetic radiation is constructed from an inorganic semiconductor, an incandescent light, or also from a light medium based on a chemical reaction.

A further advantage exists if the quantum detector of electromagnetic radiation is constructed from a photodetector made from an organic semiconducting material because the previously mentioned advantageous properties of organic semiconductors also apply to this claimed construction in terms of production, usage, and disposal.

It is also conceivable for the quantum detector to be constructed from inorganic semiconducting material. In particular, any semiconductor detector can be used as a quantum detector.

Electrically conductive interconnects are required in order to establish an electrical connection from the source and/or quantum detector to the interface. A meaningful advantage exists if the interconnects are printed between the interface and the source and/or quantum detector of electromagnetic radiation because the construction of the interconnects can quickly and easily be changed by selectively changing the print layout.

A further advantage is that this printing does not necessarily have to occur at the same time as the reaction membrane or the construction of the chemically/biologically reactive test areas is applied. It is particularly conceivable for the interconnects to be printed onto pre-fabricated rapid strip tests, where one or more protective layers are provided as needed.

As printing processes, inkjet, flat printing, gravure, and screen printing processes could be used, for instance.

If the source and/or the quantum detector of electromagnetic radiation are printed, then as mentioned previously, a very flexible customization and change is possible.

Unlike semiconductors produced with structuring processes, those made with printing processes such as inkjet, flat printing, gravure, or screen printing processes can be made significantly faster and it is easier to meet current requirements. This is a particularly decisive advantage if the source and/or the quantum detector are printed afterwards on a prefabricated rapid strip test.

If the carrier layer is constructed from a transparent laminar material with a first and a second flat face essentially parallel to each other, and if the reaction membrane is applied to the first flat face, then the decisive advantage exists that an unimpeded view of the reaction membrane applied to the first flat face is possible. The transparent carrier layer is constructed from nitrocellulose, for instance, and the transparency can be improved with concentrated triton X-114.

With this construction, it is advantageously possible to apply the quantum detector to a pre-fabricated rapid strip test subsequently because the transparent carrier layer does not impede the view of the test area. In this way, the transillumination measurement device described by the invention can be applied in a particularly advantageous manner, in a process essentially separate from that of producing the rapid strip test.

A further advantageous embodiment of the proposed invention is one where the quantum detector of electromagnetic radiation is applied to the second flat face and the source of electromagnetic radiation is applied to the section of the chemically/biologically reactive test area, spaced apart from one another by a substrate. This construction ensures that the intensity of the reaction influenced by the electromagnetic radiation emitted from the source mostly occurs in the capture area of the quantum detector. In particular, a construction as claimed essentially prevents effects that would distort the measurement, such as external light scattering.

If the source of electromagnetic radiation is applied to the second flat face and the quantum detector of electromagnetic radiation is applied to the section of the chemically/biologically reactive test area, spaced apart from one another by a substrate, then the previously mentioned advantages also apply to this claimed construction.

In one advantageous embodiment, the source is constructed as a laminar light medium for instance, and is disposed on the second flat face of the carrier layer in such a way that at least those sections of the second flat face where the reaction membrane features a test area are covered by the light medium. The advantage of this construction is that it enables backlighting of the test strip simplifying readout for the user.

Of particular advantage is a construction where at least the carrier layer along with the layers deposited on it, the source and the quantum detector of electromagnetic radiation as well as the interface are arranged in a housing, because this simplifies handling and significantly increases user protection from the sample.

Since the samples to be tested usually pose a considerable potential risk for the user (chemical/biological risk class), it is a decisive advantage if the operation of the rapid test is as simple as possible and if a reliable protection from the sample is provided.

If the interface is constructed as an electrically conductive contact, a number of existing and functionally proven contact systems could be used. Particularly advantageous are contact systems which enable a simple and reliable connection to a digital analysis device, for instance chip cards or SD cards.

If the interface is designed for contactless power and transmission of measurement results, the particular advantage exists that a measurement of the intensity of the chemical/biological reaction is possible without the need to establish an electrical contact. This is particularly important, if all contact between the user and the sample must be avoided for example, or if an electrically conductive interconnect between the rapid strip test and an analysis device is not possible due to local conditions. With the contactless power and transmission of measurement results, it is advantageously possible to construct a completely encapsulated rapid strip test.

If the reaction membrane features at least one additional chemically/biologically reactive test area where the test areas are arranged at a distance from one another, it is possible to obtain a qualitative result with respect to the validity of the performed measurement, in addition to the quantitative evaluation of the reaction intensity. With rapid strip tests, the sample is placed on the reaction membrane and then transported, generally through capillary action, towards a test area, the so-called measuring strip. The additional test area, the control strip, is then located after the measuring strip in the transport direction. This construction advantageously ensures that before it reaches the control strip, the sample must pass the measuring strip, where it can cause a chemical/biological reaction.

This control strip does not have to be sensitive to the substance for which the sample is being tested and it is sufficient that the sample reaches the control strip. Therefore, the control strip must be reactive to a substance that will definitely be present in the sample and must react to this presence with a color change. Only then is a valid result readable on the measuring strip. This construction advantageously ensures that the chemical/biological reaction is available on the measuring strip for a reasonable time in order to achieve an accurate result.

If the carrier layer features at least one additional reaction membrane and the reaction membranes are arranged at a distance from one another, it is advantageously possible to obtain several parameters in one measurement procedure from a single sample using a rapid strip test. For instance, a single blood sample could be used to determine several laboratory values. It is of particular advantage that, for instance, processing time and patient discomfort are reduced because a smaller sample can be used to determine multiple parameters.

With these so-called multiple systems, it is also possible for a separate sample to be placed on each reaction membrane. Combinations of these constructions are also possible.

If an analysis device is arranged on the carrier layer or if an analysis device is provided in the housing, then the particular advantage exists that a determination of the reaction intensity is possible without additional devices or external equipment.

A particular advantage is that the procedure to obtain the reaction intensity can be configured in a manufacturing process, and thus is immediately available for the claimed transillumination measurement device. One claimed construction provides a significant improvement in user safety.

The previously mentioned advantageous properties of organic semiconductors can be logically applied to a construction in which the analysis device is constructed from organic semiconductors. Particularly with respect to the preferred one-off use of the transillumination measurement device described by the invention, this is especially advantageous because the disposal of organic semiconductors does not require any additional procedures.

In one advantageous embodiment, the analysis device could also comprise a display medium, for instance. This would permit an immediate display, particularly a numeric display, of the detected intensity value. The display medium can also be constructed from an inorganic semiconducting material.

It is of advantage if a power source is provided to supply electrical power to the analysis device, and the power source is constructed from the group comprising galvanized elements, solar cells, and fuel cells, because self-sustaining power operation of the transillumination measurement device described by the invention is then possible.

For instance, the power source could be constructed such that it provides power for a specified period of time after being activated during a measurement procedure.

Similarly a construction is possible in which the power source is constructed as a solar cell and the incoming electromagnetic radiation is converted to electrical power. With respect to the previously mentioned one-off use, a further embodiment in which the solar cell is constructed of organic semiconducting material is of particular advantage.

The objective of the invention is also achieved by a process in which a measure of the intensity of the chemical/biological reaction is determined by the degree of attenuation. With this construction, it is advantageously possible to obtain a quantitative evaluation of the reaction intensity immediately, in addition to the qualitative evaluation of the test results of a chemical/biological reaction. It is of further advantage that qualitative evaluation is possible.

If a reference value for the waves reaching the quantum detector is determined before the insertion of the chemical/biological reaction in the test area, it is then advantageously possible to calibrate each individual rapid strip test.

Since, due to manufacturing tolerances, it is hard to predict the variance in the ground dampening of the chemically/biologically reactive test area precisely, one claimed construction is of particular advantage in that it eliminates this imprecision by obtaining, at the beginning of each measurement, a specific value of the ground dampening for the rapid strip test in use.

If the validity of the measurement can be verified through a color change in the control strip, this color change can then be used to activate the analysis device in order to accept the intensity value determined by the quantum detector of the measurement assembly.

This construction has the particular advantage that, along with the information about a valid measurement result, a start signal for the start of the measurement is provided at the same time. The analysis device does not then need to monitor the measurement assembly permanently. It is of further advantage that the quantum detector of the control assembly can be constructed in a simpler manner because it only needs to recognize a color change, as in a light/dark change, but not a gradual color change.

When the intensity value captured by the quantum detector is transferred to the analysis device, a measure for the intensity of the reaction can be determined. Since the intensity of the attenuation is proportional to the amount of substance to be tested in the sample, a measurement of the amount of this substance present is also immediately available.

The invention will be explained in more detail below with reference to examples of embodiments illustrated in the appended drawings.

The drawings are schematically simplified diagrams illustrating the following:

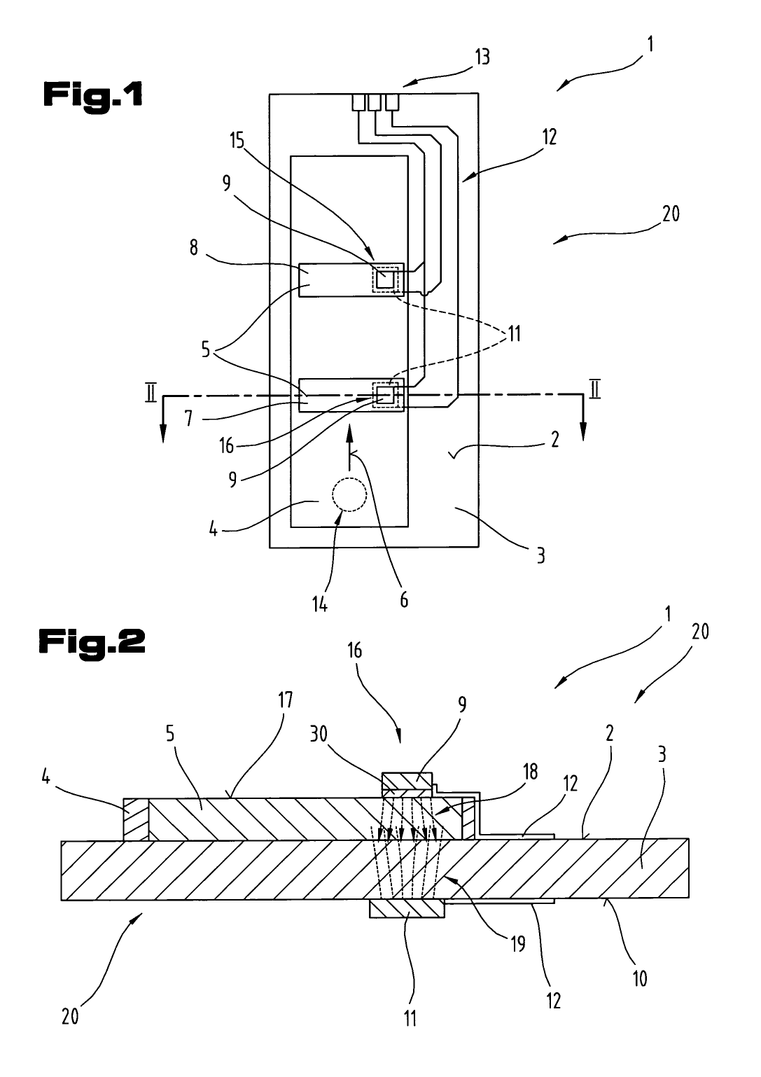

FIG. 1 the transillumination measurement device described by the invention;

FIG. 2 a cross-section from FIG. 1, not drawn to scale; 1;

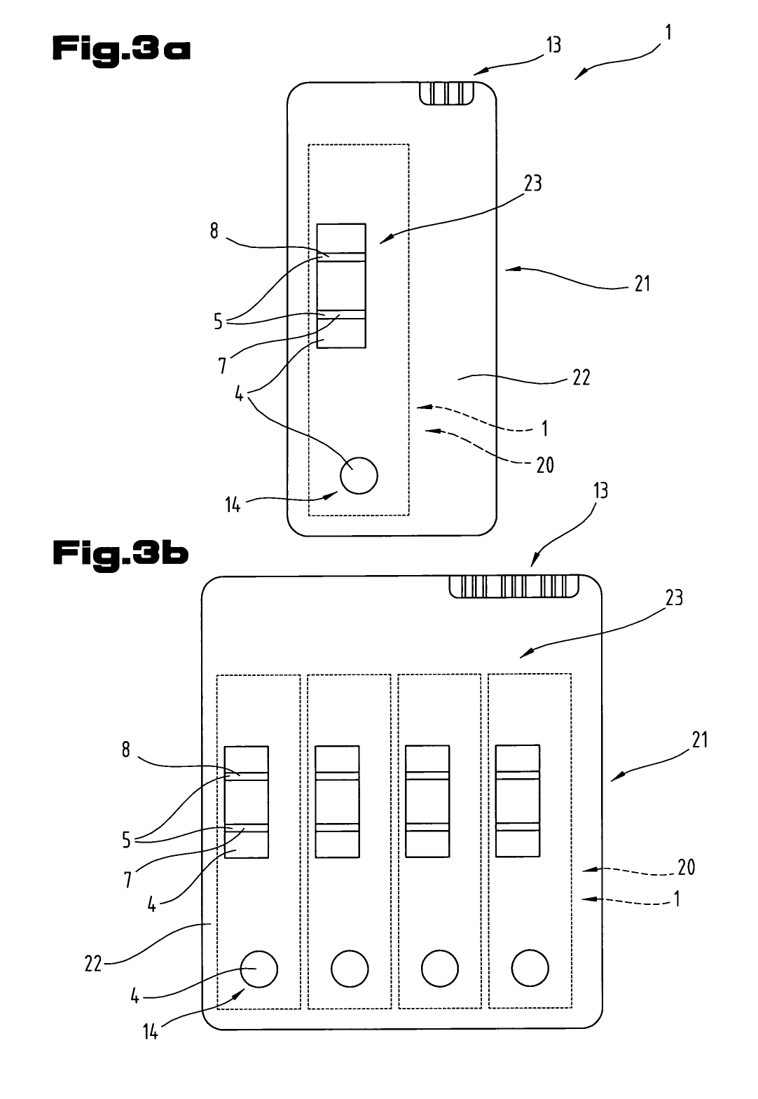

FIG. 3 a) a single rapid strip test with a transillumination measurement device integrated in the housing;
b) a multiple rapid strip test with four transillumination measurement devices integrated in the housing;

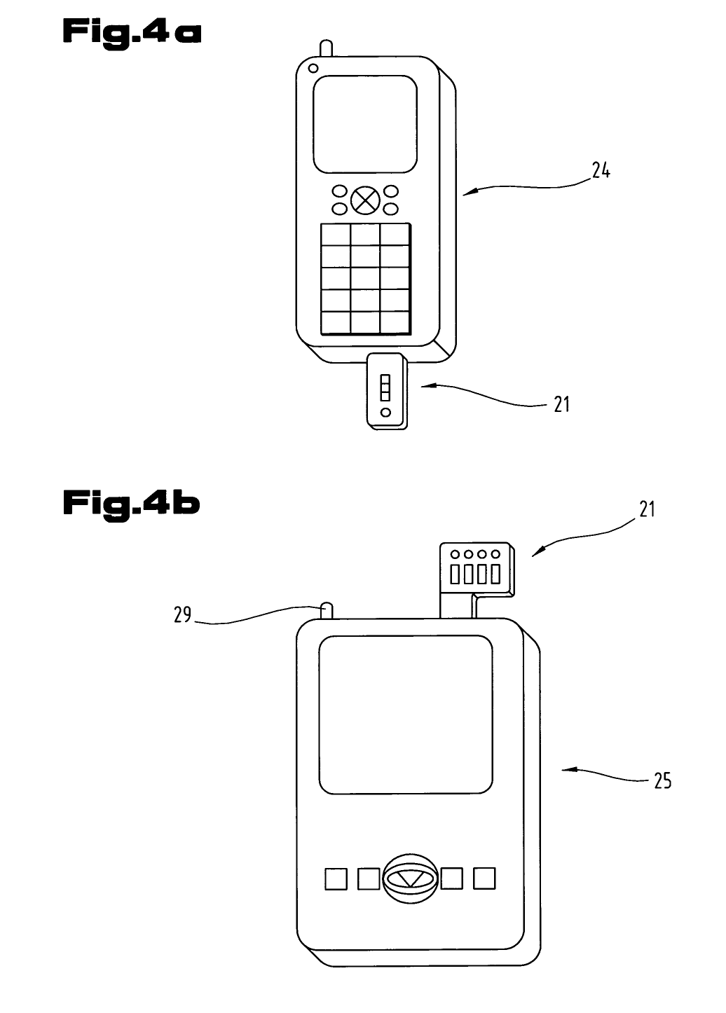

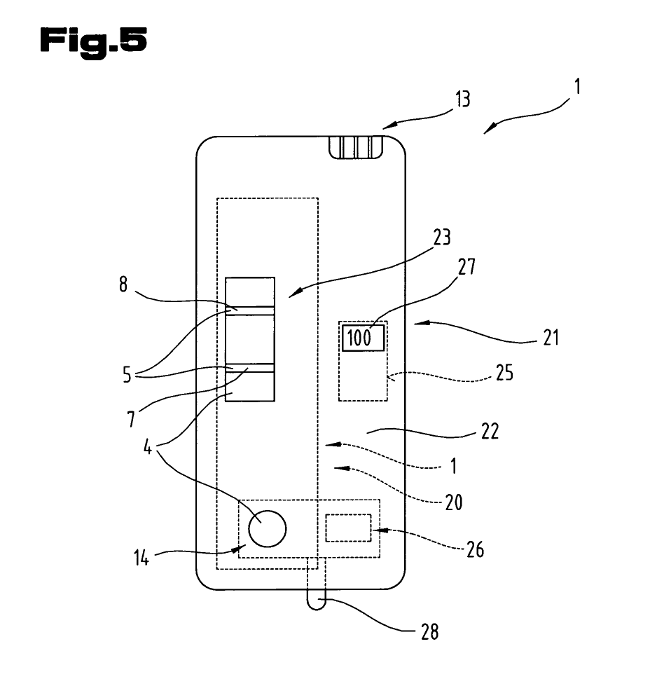

FIG. 4 a) a rapid tester connected to a data transmission device;
b) a multiple rapid tester connected to an analysis device;

FIG. 5 a rapid tester with self-sustaining power.

Firstly, it should be pointed out that the same parts described in the different embodiments are denoted by the same reference numbers and the same component names and the disclosures made throughout the description can be transposed in terms of meaning to same parts bearing the same reference numbers or same component names. Furthermore, the positions chosen for the purposes of the description, such as top, bottom, side, etc., relate to the drawing specifically being described and can be transposed in terms of meaning to a new position when another position is being described. Individual features or combinations of features from the different embodiments illustrated and described may be construed as independent inventive solutions or solutions proposed by the invention in their own right.

FIG. 1 shows a transillumination measurement device 1 as described by the invention, where a reaction membrane 4 is arranged on the first flat face 2 of the carrier layer 3. The reaction membrane 4 features two chemically/biologically reactive test areas 5 arranged at a distance from one another. The first test area 5 in the direction of flow 6 is constructed for quantitative analysis of the sample contents and will be referred to as measuring strip 7. The second test area 5 in the direction of flow 6 is constructed for qualitative assessment or validation of the test result and will be referred to as control strip 8. At measuring strip 7, the presence of a specific substance in the sample causes a reaction that is indicated by a color change, where the intensity of the color change is essentially proportional to the amount of the element contained in the sample. The control strip 8 gives a qualitative indication as to whether sufficient sample material has passed the measuring strip 7 and thus serves to verify the validity of the result determined by the measuring strip. Placed on a section of each chemically/biologically reactive test area 5 is a source of electromagnetic radiation 9 and a transparent substrate 30 is usually arranged between source 9 and test area 5. On the second flat face of the carrier layer 3, a quantum detector of electromagnetic radiation 11 is arranged in the area of a section of the chemically/biologically reactive test area 5. The quantum detector 11 and the source 9 are connected to an interface 13 by means of electrically conductive interconnects 12.

To take a measurement, a sample is placed in the application area 14 and transported further in the direction of flow 6, for instance through the capillary action of the reaction membrane 4. After a period of time determined by the capillary action of the reaction membrane 4, the sample reaches the measuring strip 7. If a specific substance is present in the sample, then a chemical/biological reaction occurs in the measuring strip, which in particular causes a color change in the measuring strip. After a further period of time, the sample reaches the control strip 8. Here, a reaction occurs with the sample or an element present in the sample, causing a color change. The result of the measuring strip 7 may be evaluated only when a color change occurs on the control strip 8. An analysis device (not pictured) connected via the interface 13 waits until a color change of the control strip 8 is recognized by the control assembly 15. The attenuation of the electromagnetic radiation emitted by the source 9 is then determined by the measurement assembly 16, and a measure of the amount of the substance present in the sample is determined.

Since, due to hard-to-predict factors such as manufacturing tolerances, storage and environmental conditions, the control assembly 15 and the measurement assembly 16 could also exhibit ground attenuation without the presence of a sample, it is conceivable in one advantageous embodiment to perform a reference measurement before the beginning of the measurement. The electromagnetic radiation emitted by the source 9 is therefore captured by the quantum detectors 11 on the measurement assembly 16 and the control assembly 15 and temporarily stored by the analysis device (not pictured) as a reference value. During the measurement, the temporarily saved reference value is used to correct the inherent dampening. This reference measure requires no additional work steps by the user, and offers a significant reduction in system errors because errors that are not measurement-specific are eliminated.

FIG. 2 shows a cross-section of the transillumination measurement device described by the invention. The plane of the cross-section lies in the region of the chemically/biologically reactive test area 5, in particular the measurement assembly 16, as shown in FIG. 1. A reaction membrane 4 is arranged on the first flat face 2 of the carrier layer 3, and features a chemically/biologically reactive test area 5. A source 9 and a quantum detector 11 of electromagnetic radiation are arranged opposite one another, the quantum detector 11 of electromagnetic radiation being placed on the second flat face 10 of the carrier layer and the source of electromagnetic radiation 9 being placed on the surface 17 of the test area, spaced apart from one another by a transparent substrate 30. The quantum detector 11 and the source 9 are connected to an interface via an electrically conductive interconnect 12. The portion of the source 9 emitting electromagnetic radiation 18 thus faces the capture area 19 of the quantum detector 11.

The sample placed in the sample application area is transported toward the portion of the reaction membrane covered with a chemically/biologically reactive test area. In the test area, the presence of specific elements in the sample lead to a chemical/biological reaction, resulting in a color change of the test area.

The substrate 30, the test area 5, and the carrier layer 3 are at least semitransparent in the spectral range of the electromagnetic radiation 18 emitted by the source 9. Preferably, the carrier layer 3 is constructed from a transparent material, for instance nitrocellulose, and the transparency of the material can be improved with concentrated triton X-114. Since only materials that are at least semitransparent are disposed between the source 9 and the quantum detector 11, the electromagnetic radiation 18 emitted by the source acts primarily in the capture area 19 of the quantum detector 11. Since the intensity of the emitted electromagnetic radiation is preferably constant, a radiation-dampening color change in the test strip 5 acts immediately on the intensity of the electromagnetic radiation reaching the capture area 19 of the quantum detector.

Since the source 9 and the quantum detector 11 of electromagnetic radiation are respectively arranged on the second flat face 10 of the carrier layer and on the surface of the test area 17, spaced apart from one another by the substrate 30, the transillumination measurement device 1 described by the invention is manufactured independently of the production of the rapid strip test 20. It is of particular advantage that the transillumination measurement device 1 can also be applied after production of the rapid strip test 20.

Rapid strip tests are generally intended for one-off use because the sample typically poses a biological or chemical/biological risk. With respect to the necessary disposal or destruction of the rapid strip test, a construction with organic semiconducting materials is of particular advantage because in this way, no complex or special process is needed. Furthermore, organic semiconductors can be produced in a particularly advantageous manner using a printing process.

FIG. 3a shows a rapid tester 21, in which a transillumination measurement device 1 described by the invention or a rapid strip test 20 is placed in a housing 22, and the source and the quantum detector of electromagnetic radiation are electrically connected to an interface 13. The sample is thus placed in an application area 14 on the reaction membrane 4 and transported from there towards the chemically/biologically reactive test area 5, for instance due to capillary action.

To permit visual control of the test result, a viewing window 23 is provided in the housing 22, affording a view of the two test strips 5, particularly the measuring strip 7 and the control strip 8. With this construction, it is also possible to read out a qualitative test result. The structural design largely prevents contact between the user and the sample.

FIG. 3b shows a further construction of a rapid tester 21, in which a total of four rapid strip tests 20 are arranged in a single housing 22. Also in this case, the source and the quantum detector of each transillumination measurement device 1 are electrically connected to an interface 13.

In the illustrated construction, there are four individual rapid strip tests 20, each with its own sample application area 14. It is also conceivable that only one sample application area exists, where multiple tests could be performed with one sample; in other words, from a single sample the concentrations of multiple substances could be evaluated.

FIG. 4a shows a rapid tester 21 connected to a data transmission device 24. Rapid testers are often used by medical personnel, for instance, to determine laboratory measurements from blood or urine. The transillumination measurement device described by the invention would greatly simplify this handling, but in particular provides a safer and more accurate readout. Thus, medically trained personnel are not absolutely necessary for the correct performance of the measurement because a person or patient can perform the measurement unaided. If the rapid tester is connected to a data transmission device configured to determine the intensity of the chemical/biological reaction, then the captured measurements can be transmitted to a control station or to a doctor. This offers a particular advantage if measurements need to be taken over a longer period of time and the results recorded, because it does not require a time-consuming doctor's visit.

However, this construction is not restricted to medical applications and is valid for any applications in which rapid testers can perform an evaluation of a substance contained in a sample.

It is also conceivable for an automatic measurement station to determines a measurement value periodically and transmit the result to a control station using a data transmission device, for instance.

FIG. 4b shows a rapid tester 21 connected to an analysis device 25. For point-of-use evaluation, the rapid tester can be connected via the interface to a handheld, laptop, or similar device. The analysis device determines the intensity value based on the color change in the measuring strip and is also advantageously configured to capture the determined measurement value as digital data. It is of further advantage if the analysis device is designed to provide a graphic display of the measurement result. It is also conceivable for the analysis device to establish a digital connection, for instance to a control station, via a communications medium 29.

FIG. 5 shows a rapid tester 21 with self-sustaining power according to one advantageous embodiment of the transillumination measurement device described by the invention. Disposed in the housing 22 are an analysis device 25 and a power source 26, and the analysis device also features a display medium 27. The power source 26 is constructed such that it provides power for a specified period of time after activation. It is conceivable, for instance, that in the inactive mode (delivery mode), an activation medium 28 could cover or seal the sample application area 14 and the power source. At the beginning of the measurement, the user removes the activation medium 28 and thus exposes the sample application area 14 and further activates the power source 28. After the measurement has been performed, the display medium displays the determined measurement value to the user.

It is also conceivable for the power source 28 to be constructed as a solar cell, in particular constructed from an organic semiconducting material.

To avoid unnecessary repetition, reference may be made to the description above for details of other embodiments and to the claims for details of other variants.

As a matter of form, it should be pointed out, that for better understanding of the construction of the device 1, it and its components may be partially illustrated not to scale and/or enlarged and/or reduced.

The objective underlying the individual inventive solutions may be found in the description.

The individual constructions shown in FIGS. 1 to 5 may be used to construct independent solutions described by the invention. These objectives and solutions according to the invention fall within the scope of this description.

### LIST OF REFERENCE NUMBERS

1 Transillumination measurement device
2 First flat face
3 Carrier layer
4 Reaction membrane
5 Chemically/biologically reactive test area
6 Direction of flow
7 Measuring strip
8 Control strip
9 Source of electromagnetic radiation
10 Second flat face
11 Quantum detector of electromagnetic radiation
12 Interconnect
13 Interface
14 Sample application area
15 Control assembly
16 Measurement assembly
17 Surface
18 Electromagnetic radiation
19 Capture area of the quantum detector
20 Rapid test strip
21 Rapid tester
22 Housing
23 View window
24 Data transmission device
25 Analysis device
26 Power source
27 Display medium
28 Activation medium
29 Communications medium
30 Substrate

1. A transillumination measurement device, for determining the intensity of a chemical/biological reaction, comprising at least one carrier layer, a source, and a quantum detector of electromagnetic radiation, and an interface, wherein a reaction membrane is applied to the carrier layer and the reaction membrane features at least one chemically/biologically reactive test area, and the electromagnetic radiation emitted from the source lies in a first optical spectral range and the quantum detector features an area that is sensitive to electromagnetic radiation in a second optical spectral range, whereby the first and second spectral ranges at least partially overlap, and whereby the source and the quantum detector of electromagnetic radiation are electrically connected to the interface; wherein the source and the quantum detector are arranged opposite one another, the direction of the electromagnetic radiation from the source points towards the capture area of the quantum detector, and a section of the chemically/biologically reactive test area is placed between the source and the quantum detector in the direction of the electromagnetic radiation.

2. The transillumination measurement device according to claim 1, wherein the source of electromagnetic radiation is constructed from a light-emitting diode made from an organic semiconducting material (OLED).

3. The transillumination measurement device according to claim 1, wherein the quantum detector of electromagnetic radiation is constructed from a photodetector made from an organic semiconducting material.

4. The transillumination measurement device according to claim 1, wherein the interconnects are printed between the interface and the source and/or the quantum detector of electromagnetic radiation.

5. The transillumination measurement device according to claim 1, wherein the source of electromagnetic radiation and/or the quantum detector of electromagnetic radiation are printed.

6. The transillumination measurement device according to claim 1, wherein the carrier layer is constructed from a transparent laminar material with a first and a second flat face disposed essentially parallel to each other, and the reaction membrane is applied to the first flat face.

7. The transillumination measurement device according to claim 6, wherein the quantum detector of electromagnetic radiation is applied to the second flat face and the source of electromagnetic radiation is applied to the section of the chemically/biologically reactive test area, spaced apart from one another by a substrate.

8. The transillumination measurement device according to claim 6, wherein the source of electromagnetic radiation is applied to the second flat face and the quantum detector of electromagnetic radiation is applied to the section of the chemically/biologically reactive test area.

9. The transillumination measurement device according to claim 1, wherein at least the carrier layer along with the layers deposited on it, the source and the quantum detector of electromagnetic radiation as well as the interface are arranged in a housing.

10. The transillumination measurement device according to claim 1, wherein the interface is constructed as an electrically conductive contact.

11. The transillumination measurement device according to claim 1, wherein the interface is constructed for contactless power and/or transmission of measurement results.

12. The transillumination measurement device according to claim 1, wherein the reaction membrane comprises at least one additional chemically/biologically reactive test area and the test areas are arranged at a distance apart from one another.

13. The transillumination measurement device according to claim 1, wherein at least one additional reaction membrane is applied to the carrier layer and the reaction membranes are arranged at a distance apart from one another.

14. The transillumination measurement device according to claim 1, further comprising an analysis device arranged on the carrier layer.

15. The transillumination measurement device according to claim 1, wherein an analysis device is disposed in the housing.

16. The transillumination measurement device according to claim 1, further comprising an analysis device constructed from organic semiconductors.

17. The transillumination measurement device according to claim 15, wherein a power source is provided to supply the analysis device with electrical power and the power source is constructed from the group comprising galvanized elements, solar cells, and fuel cells.

18. A process to determine the intensity of a chemical/biological reaction, comprising a transillumination measurement device as in claim 1, wherein in addition to the one chemically/biologically reactive test area, the so-called measuring strip, the reaction membrane has another chemically/biologically reactive test area, the so-called control strip, disposed at a distance apart from it, and the electromagnetic radiation emitted from the source is attenuated by the chemical/biological reaction in the test area, and the received electromagnetic waves are converted by the quantum detector into an electrical signal proportional to the intensity of the incident waves, wherein a measure of the intensity of the chemical/biological reaction is determined from the degree of attenuation.

19. The process according to claim 18, wherein before the chemical/biological reaction is placed in the test area, a reference value for the waves reaching the quantum detector is determined.

20. The process according to claim 18, wherein the validity of the measurement is verified by a color change in the control strip.

21. The process according to claim 18, wherein the analysis device receives the intensity value captured by the quantum detector, and from it determines a measure for the intensity of the reaction.
